(19) United States
(12) Patent Application Publication
(10) Pub. No.: US 2026/0052477 A1
(43) Pub. Date: Feb. 19, 2026

(54) MODIFICATION PERIODICITY FOR AN UPLINK WAKEUP SIGNAL CONFIGURATION

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Jianghong LUO, Skillman, NJ (US)

(21) Appl. No.: 19/236,549

(22) Filed: Jun. 12, 2025

Related U.S. Application Data
(60) Provisional application No. 63/684,216, filed on Aug. 16, 2024.

(51) Int. Cl. H04W 52/02; H04W 28/06; H04W 64/00

(52) U.S. Cl. CPC H04W 52/0235; H04W 28/06; H04W 64/00

(57) ABSTRACT

Certain aspects of the present disclosure provide techniques for obtaining an uplink wakeup signal configuration from a first cell; obtaining an indication of a modification periodicity for the uplink wakeup signal configuration, the modification periodicity indicating a length of time for which the uplink wakeup signal configuration is valid; and sending, to a second cell, an uplink wakeup signal in accordance with the modification periodicity using the uplink wakeup signal configuration.

### CROSS-REFERENCE TO RELATED APPLICATION(S)

The present Application for Patent claims benefit of and priority to U.S. Provisional Application No. 63/684,216, filed Aug. 16, 2024, which is hereby expressly incorporated by reference herein in its entirety.

### INTRODUCTION

### Field of the Disclosure

Aspects of the present disclosure relate to wireless communications, and more particularly, to techniques for a modification periodicity for an uplink wakeup signal configuration.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provide a method for wireless communications by a user equipment (UE). The method includes obtaining an uplink wakeup signal configuration from a first cell; obtaining an indication of a modification periodicity for the uplink wakeup signal configuration, the modification periodicity indicating a length of time for which the uplink wakeup signal configuration is valid; and sending, to a second cell, an uplink wakeup signal in accordance with the modification periodicity using the uplink wakeup signal configuration.

Some aspects provide a method for wireless communications by a network entity. The method includes sending an uplink wakeup signal configuration; and sending an indication of a modification periodicity for the uplink wakeup signal configuration, the modification periodicity indicating a length of time for which the uplink wakeup signal configuration is valid.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 is a diagram illustrating an example of a paging cycle and a system information (SI) modification period.

FIG. 6 is a diagram illustrating an example of SI modification using an SI modification period.

FIG. 7 is a diagram illustrating an example of uplink wakeup signal (UL-WUS) transmission in association with an assisting cell and an on-demand system information block 1 (OD-SIB1) cell.

FIG. 8 is a diagram illustrating an example of an UL-WUS modification period.

FIG. 9 is a diagram illustrating an example of signaling associated with an UL-WUS modification period.

FIG. 10A is a diagram illustrating an example of discarding an UL-WUS configuration based on an area.

FIG. 10B is a diagram illustrating an example of retaining an UL-WUS configuration based on an area.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for a modification periodicity for an uplink wakeup signal configuration.

Paging is a mechanism for notifying user equipment (UEs) of incoming messages or events. In 5G, paging is used to wake up UEs from a power-saving state, allowing the UEs to receive important information such as incoming calls, messages, or system updates. The paging process involves a network entity transmitting a paging message to a UE, which is typically broadcasted over a wide area to ensure that the UE can receive it even when it is not actively connected to the network. The paging message includes information such as an identity of the UE, a type of message or event, and any relevant parameters or instructions. By efficiently waking up UEs and delivering information, paging helps ensure seamless and reliable communication in 5G networks.

A network entity may broadcast system information to UEs covered by the network entity. System information may provide information related to the network, such as cell configurations, parameters, and capabilities. One form of system information is System Information Block 1 (SIB1). SIB1 provides UEs with information about the network, including a cell's identity, configuration, and parameters. In some deployments, SIB1 is transmitted periodically, such as every 160 milliseconds (ms). The transmission of SIB1 may use some amount of power and overhead.

To mitigate this power consumption and overhead, a network entity may implement on-demand SIB1 (OD-SIB1) transmission. On-demand SIB1 transmission is a mechanism that allows UEs to request and receive SIB1 from a network entity at any time. For example, the network entity may not transmit SIB1 periodically, and may instead transmit SIB1 upon receiving a request from a UE. The request may be referred to herein as an uplink wakeup signal (UL-WUS). This allows the UE to obtain SIB1 when the UE has a use for SIB1 (such as accessing a cell provided by the network entity) and otherwise saves power and overhead that would be spent on periodic SIB1 transmission. A cell that implements OD-SIB1 transmission may be referred to herein as an OD-SIB1 cell.

A UE may transmit a UL-WUS according to a UL-WUS configuration. For example, the UL-WUS configuration may indicate a resource for the UL-WUS, a preamble, a sequence, or the like. A UL-WUS configuration for an OD-SIB1 cell may be provided to the UE via system information from another cell, referred to herein as an assisting cell or as Cell A. To transmit a UL-WUS, the UE may tune to the assisting cell, check whether the UL-WUS configuration remains valid (such as by reference to a validity tag transmitted by the assisting cell), and then tune back to the OD-SIB1 cell and transmit the UL-WUS according to the UL-WUS configuration.

Some amount of delay may be involved in checking whether the UL-WUS configuration remains valid. For example, to eliminate the possibility of UL-WUS transmission using an outdated configuration, the UE may need to check the validity tag each time a system information (SI) modification period of the assisting cell has elapsed. This may consume radio resources and introduce latency to UL-WUS transmission. Furthermore, it may be expected that the UL-WUS configuration may rarely change, or may change on a longer timescale than the SI modification period of the assisting cell. Thus, the UE may frequently check a validity tag with limited benefit. If the UE does not check the validity tag, the UE may transmit a UL-WUS using an outdated UL-WUS configuration, leading to difficulty obtaining SIB1 and connecting to the OD-SIB1 cell.

Aspects of the present disclosure relate generally to OD-SIB1 transmission. Some aspects more specifically relate to a UL-WUS modification periodicity for a UL-WUS configuration. For example, a UL-WUS configuration may be associated with a UL-WUS modification periodicity. This UL-WUS modification periodicity may indicate a length of time (such as a minimum length of time) for which the UL-WUS configuration is valid. Thus, within the UL-WUS modification periodicity, the UE does not need to tune to the assisting cell to check the UL-WUS configuration's validity. In some aspects, the UL-WUS modification periodicity may have a different length than the SI modification period. For example, the UL-WUS modification periodicity may be longer than the SI modification periodicity. Some aspects described herein provide updating of a UL-WUS configuration (e.g., irrespective of whether the UL-WUS modification periodicity has elapsed) in accordance with a trigger condition. For example, the trigger condition may relate to the UE having moved further than a threshold maximum movement distance, or may relate to the UE moving out of an area associated with the assisting cell (or the OD-SIB1 cell).

Aspects of the present disclosure may be used to realize one or more of the following potential advantages. In some aspects, by providing the UL-WUS modification periodicity, a number of tune-aways to the assisting cell may be reduced, thereby reducing latency associated with OD-SIB1 acquisition and resource usage at the UE. By providing a UL-WUS modification periodicity that is longer than an SI modification periodicity, the number of tune-aways is further reduced and the UE can transmit UL-WUSs without regard for their validity so long as the UE is within the UL-WUS modification periodicity. In some aspects, by providing updating of the UL-WUS configuration in accordance with the trigger condition, a situation is avoided where the UE moves into a coverage of another OD-SIB1 cell (associated with a different assisting cell and a different UL-WUS configuration) that has the same cell parameters and transmits a UL-WUS using an incorrect UL-WUS configuration.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

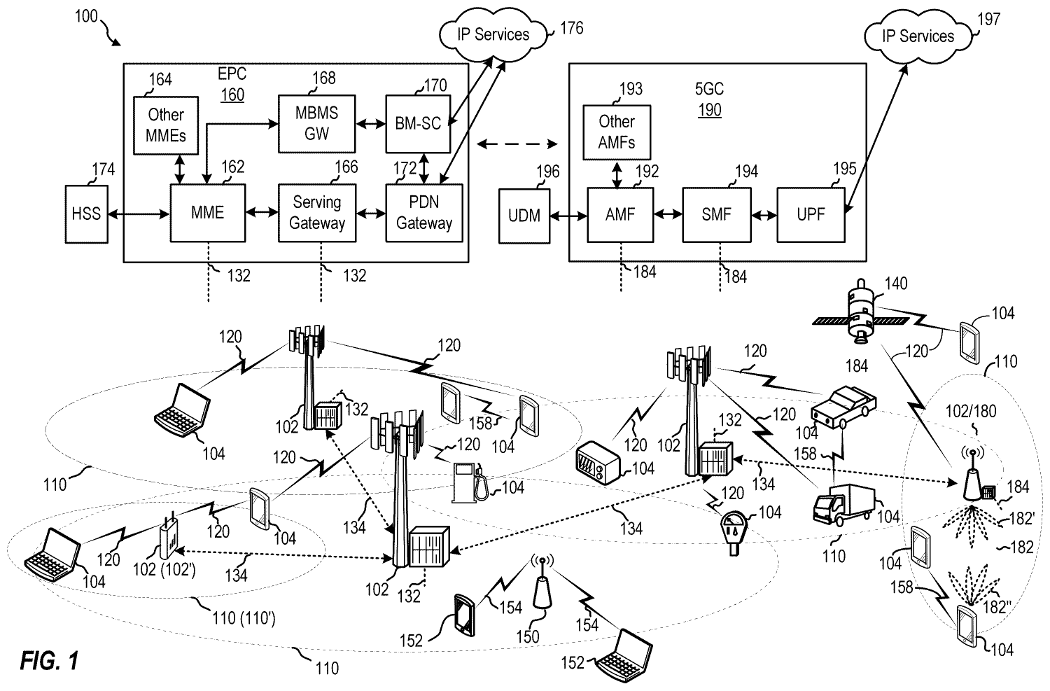

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or spaceborne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cells.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

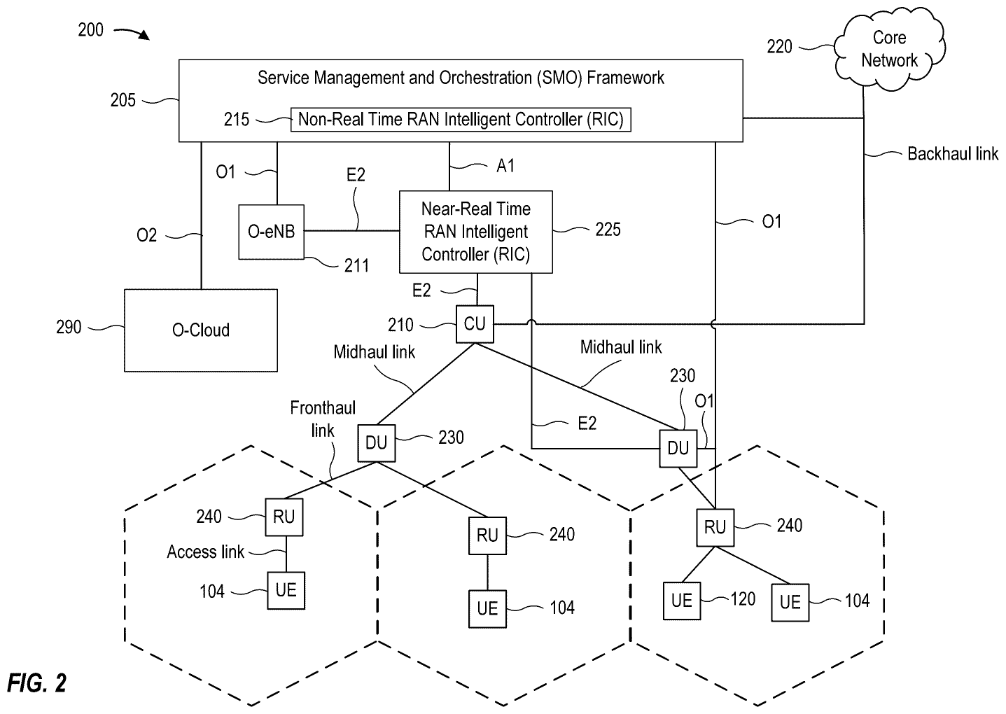

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz - 7125 MHz, which is often referred to (interchangeably) as “Sub-6 GHz”. Similarly, 3GPP currently defines Frequency Range 2 (FR2) as including 24,250 MHz - 71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz - 52,600 MHz and a second sub-range FR2-2 including 52,600 MHz - 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

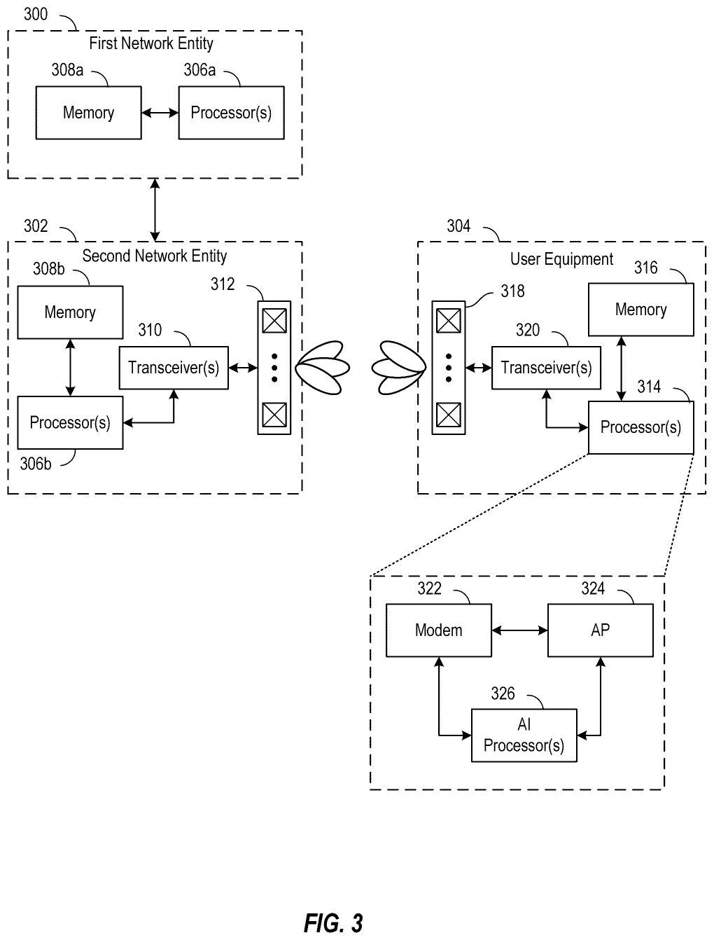

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include one or more processors 306 (illustrated as “processor(s) 306a” and “processor(s) 306b”) and one or more memories 308 (illustrated as “one or more memories 308a” and “one or more memories 308b”) coupled to the one or more processors 306. The one or more processors 306 may implement various functions described herein related to wireless communications or other operations of a network entity. For example, the one or more processors 306 may include or implement one or more controllers/processors, one or more modems, one or more AI processors, one or more schedulers, one or more control functions, one or more network controllers, one or more application processors, or the like. In some aspects, the one or more processors 306 may perform processing (such as digital signal processing) of data, control information, or signals received or transmitted by a network entity. For example, the one or more processors 306 may include a coder, a decoder, a multiplexer, a demultiplexer, a transmit MIMO processor, a transmit processor, a receive processor, a receive MIMO detector, an automatic gain control component, or the like.

The one or more memories 308 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 308 may store data and program code for first network entity 300 and/or second network entity 302.

As further shown, second network entity 302 includes one or more transceivers 310. Transceiver 310 may perform processing related to implementing physical layer (e.g., radio, air interface) communication with other devices such as UE 304. Transceiver 310 may include one or more radio frequency (RF) components, such as an RF transceiver, a front-end module (e.g., an RF front-end (RFFE)), or the like. For example, transceiver 310 may include a transmit path (also referred to as a transmit chain), a receive path (also referred to as a receive chain), and/or an interface with one or more antennas 312.

The one or more antennas 312 may perform wireless transmission and reception of signals. The one or more antennas 312 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes one or more processors 314, one or more memories 316, one or more antennas 318, one or more transceivers 320, and/or other aspects, which enable wireless transmission and reception of data.

The one or more processors 314 may be, or may include, a chip, a system on chip (SoC), a system in package (SiP), a chipset, a package, or a device. As shown, in some examples, the one or more processors 314 may include one or more modems 322, one or more application processors (APs) 324, one or more AI processors 326, a combination thereof, and/or another form of processor.

Modem 322 may include a digital signal processor that converts information into a waveform for analog signal transmission (e.g., via modulation) and/or converts the waveform of a received signal into information (e.g., via demodulation). Modem 322 may process information or waveforms in connection with signal transmission or reception. For example, modem 322 may include a coder, a decoder, a multiplexer, a demultiplexer, a transmit MIMO processor, a transmit processor, a receive processor, a receive MIMO detector, an automatic gain control component, or the like.

AP 324 may perform processing relating to an operating system and/or a higher layer application of the UE 304. For example, AP 324 may provide a higher-level operating system (HLOS), software, audio or video processing, graphics processing, or the like. In some examples, AP 324 may be a data source (e.g., for transmissions) or a data sink (e.g., for receptions).

Transceiver 320 may perform processing related to implementing physical layer (e.g., radio, air interface) communication with other devices such as other UEs 304 or second network entity 302. Transceiver 320 may include one or more RF components, such as an RF transceiver, a front-end module (e.g., an RFFE), or the like. For example, transceiver 320 may include a transmit path (also referred to as a transmit chain), a receive path (also referred to as a receive chain), and/or an interface with one or more antennas 318.

The one or more antennas 318 may perform wireless transmission and reception of signals. The one or more antennas 318 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the one or more processors 306b (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The one or more processors 306b (e.g., the transmit processor) may process (e.g., encode and symbol map) the data and control information to obtain data symbols and control symbols, respectively. The one or more processors 306b may also generate reference symbols, such as for the primary synchronization signal (PSS), secondary synchronization signal (SSS), PBCH demodulation reference signal (DMRS), or channel state information reference signal (CSI-RS).

The one or more processors 306b (e.g., a TX MIMO processor) may perform spatial processing (e.g., precoding) on the data symbols, the control symbols, and/or the reference symbols, if applicable, and may provide output symbol streams to one or more modulators of the one or more processors 306b. The one or more modulators may process one or more respective output symbol streams to obtain an output sample stream. Transceiver 310 may process (e.g., convert to analog, amplify, filter, and upconvert) the output sample stream to obtain a downlink signal. Second network entity 302 may transmit the downlink signal via antenna 312.

In order to receive the downlink transmission at UE 304 (or a sidelink transmission from another UE), antenna 318 may receive the downlink signal and may provide received signals to transceiver 320. Transceiver 320 may condition (e.g., filter, amplify, downconvert, and digitize) the received signals to obtain input samples. Transceiver 320 and/or the one or more processors 314 may further process the input samples to obtain received symbols.

The one or more processors 314 (e.g., modem 322, an RX MIMO detector) may obtain the received symbols, perform MIMO detection on the received symbols if applicable, and provide detected symbols. The one or more processors 314 (e.g., modem 322, a receive processor) may process (e.g., de-interleave and decode) the detected symbols. The one or more processors 314 may provide decoded data for the UE 304 (e.g., to an AP 324) and/or decoded control information (e.g., to a controller/processor of the one or more processors 314).

For an example uplink transmission or a sidelink transmission from UE 304, the one or more processors 314 (e.g., modem 322, a transmit processor) may receive and process data and/or control information to obtain a set of symbols for transmission. The data may be for the physical uplink shared channel (PUSCH), and may be received from a data source such as the AP 324. The control information may be for the physical uplink control channel (PUCCH), and may be received, for example, from a controller/processor of the one or more processors 314. The one or more processors 314 (e.g., modem 322, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the one or more processors 314 (e.g., modem 322, a TX MIMO processor), further processed by transceiver 320 (e.g., for SC-FDM), and transmitted to second network entity 302.

At second network entity 302, the uplink signals from UE 304 may be received by antenna 312, conditioned by transceiver 310 (e.g., filtered, amplified, downconverted, and digitized), detected (e.g., by the one or more processors 306b such as a modem and/or an RX MIMO detector), and further processed by the one or more processors 306b (e.g., a modem and/or a receive processor) to obtain decoded data and control information sent by UE 304. The one or more processors 306b may provide the decoded data and the decoded control information (such as to a controller/processor of the one or more processors 306b, an AP, first network entity 300, or another entity).

In various aspects, first network entity 300, second network entity 302, or BS 102 may be described as transmitting or receiving various types of data associated with the methods described herein. In these contexts, “transmitting” may refer to various mechanisms of outputting data, such as sending or outputting data from the one or more processors 306, one or more memories 308, transceiver 310, antenna 312, and/or other aspects described herein. Similarly, “receiving” may refer to various mechanisms of obtaining data, such as obtaining data from the one or more processors 306, one or more memories 308, transceiver 310, antenna 312, and/or other aspects described herein.

In various aspects, UE 304 or UE 104 may be described as transmitting or receiving various types of data associated with the methods described herein. In these contexts, “transmitting” may refer to various mechanisms of outputting data, such as sending or outputting data from the one or more processors 314, one or more memories 316, transceiver 320, antenna 318, and/or other aspects described herein. Similarly, “receiving” may refer to various mechanisms of obtaining data, such as obtaining data from the one or more processors 314, one or more memories 316, transceiver 320, antenna 318, and/or other aspects described herein.

As used herein, “sending” by a device may include sending (such as wirelessly, via a wired connection, or both) to a recipient directly or via another device. As another example, “sending” may include sending internally to a device (such as the UE 304, first network entity 300, or second network entity 302) by a process to memory.

As used herein, “obtaining” by a device may include obtaining (such as wirelessly, via a wired connection, or both) from a recipient directly or via another device. As another example, “obtaining” may include obtaining internally to a device (such as the UE 304, first network entity 300, or second network entity 302) by a process from memory.

As used herein, “communicating” by a device may include sending, obtaining, receiving, and/or transmitting a communication. “Communicating” can refer to communication with another device or internal communication of the device.

In various aspects, the one or more processors 306 or 314 may include one or more AI processors (such as AI processor 326 of the one or more processors 314). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

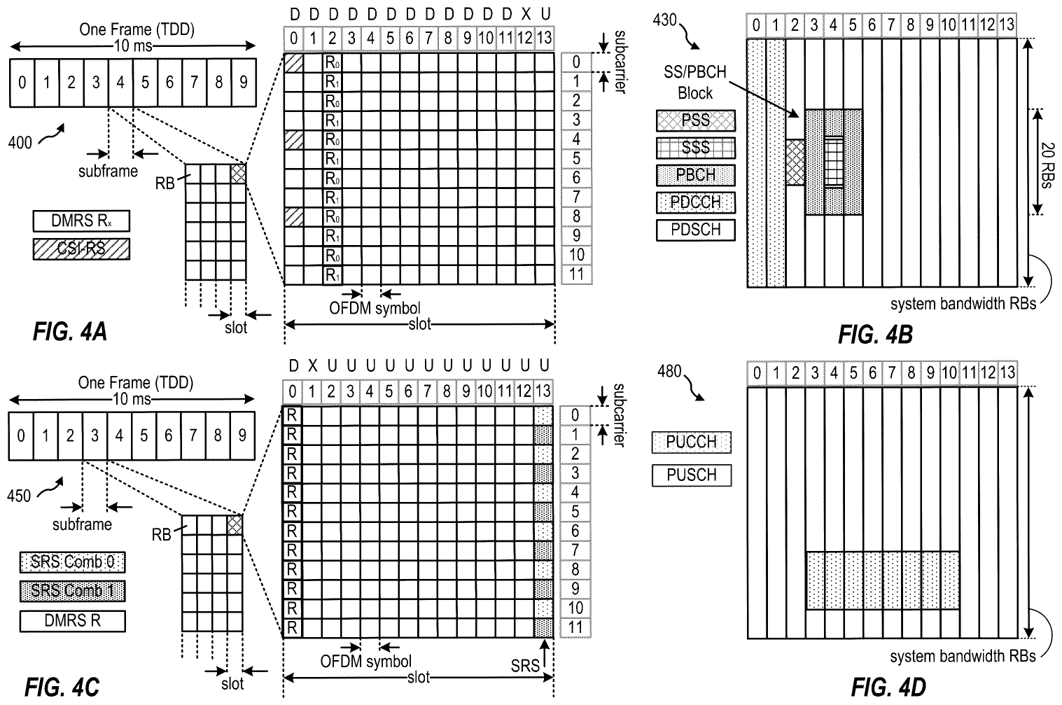

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

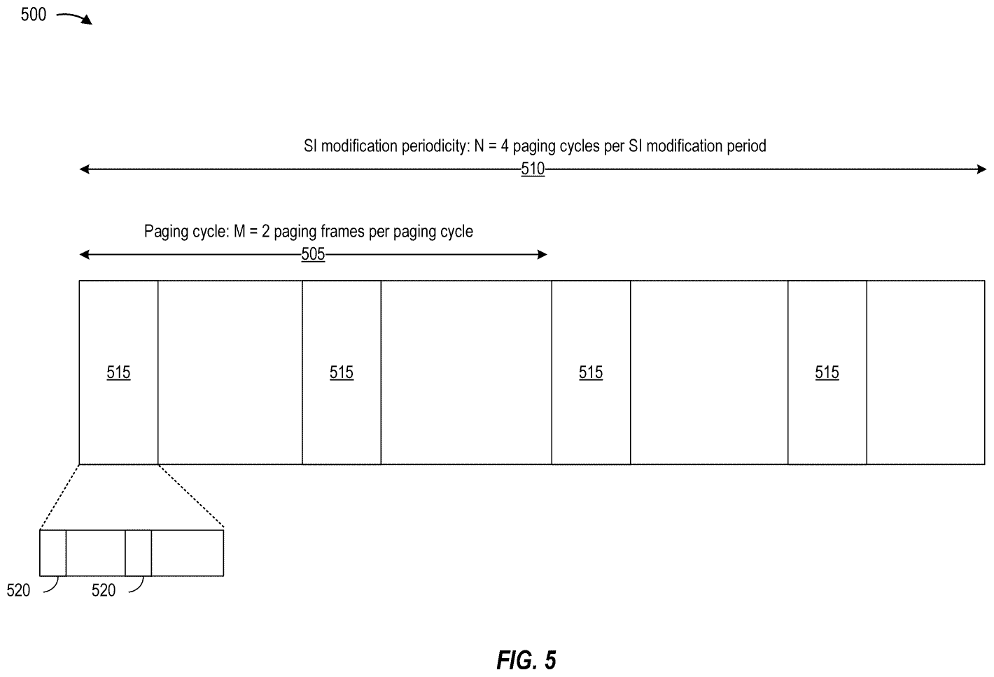

FIG. 5 is a diagram illustrating an example 500 of a paging cycle 505 and an SI modification period 510. A network entity, such as network entity 300 or network entity 302, may provide a paging configuration via one or more SIBs such as SIB2. The paging configuration may define the paging cycle 505 and/or the SI modification period 510.

A paging cycle 505 may be associated with a number of paging frames 515 per paging cycle 505. The number of paging frames 515 per paging cycle 505 may be denoted M, where M=2 in example 500. Potential values of M may include 1, 2, 4, 8, 16, or the like. In some aspects, a paging frame 515 may be a radio frame, and may be defined relative to a system frame number according to a paging frame offset.

A paging frame 515 may include one or more paging occasions (POs) 520. A PO 520 is a time resource on which the UE monitors for paging. A UE may identify a PO 520 using a UE identifier of the UE, which reduces collision between multiple UEs on the same paging frame 515 or PO 520. A UE may monitor one PO 520 per paging cycle based on a temporary mobile subscriber identity (TMSI) of the UE.

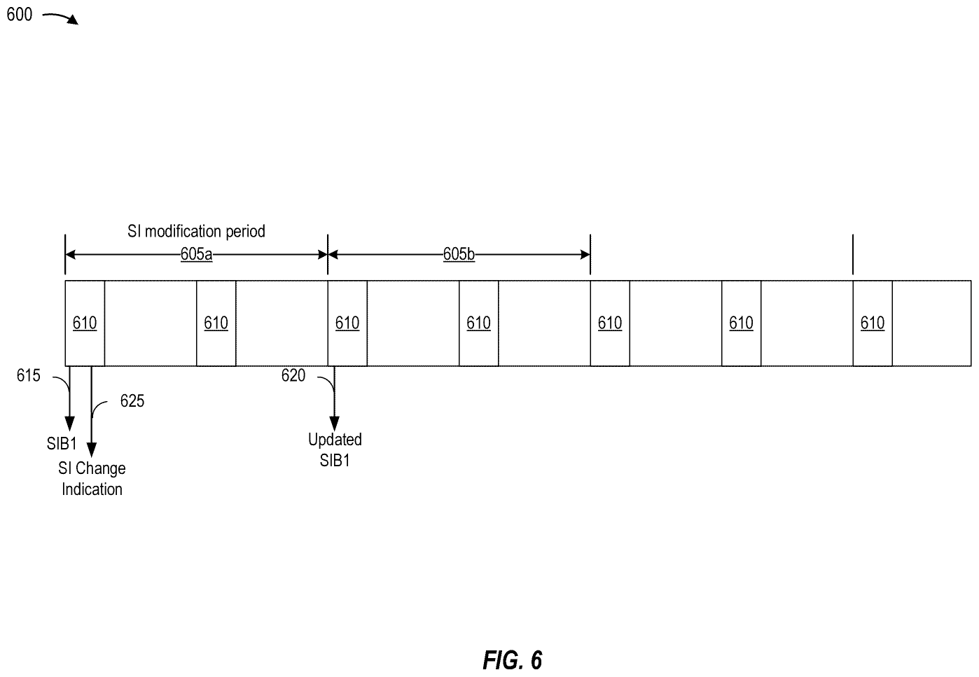

The SI modification period 510 indicates a periodicity in terms of a number of paging cycles. The SI modification period 510 may be configured via a SIB such as SIB1. In some aspects, the SI modification period 510 may be aligned with a system frame number (SFN) boundary. In some aspects, the SI modification period 510 may be an integer multiple of a periodicity of SIB1. If a network entity is to change SI of the network entity, the network entity may provide an SI change indication in a first SI modification period 510, such that UEs obtain the changed SI in a second (subsequent) SI modification period 510. Thus, the SI modification period 510 provides a minimum length of time to modify system information of the UE. The operation of the SI modification period is described in more detail in connection with FIG. 6.

FIG. 6 is a diagram illustrating an example 600 of SI modification using an SI modification period 605 (e.g., SI modification period 510). As shown, example 600 includes the SI modification period 605 and a number of POs 610 (e.g., PO 520). A paging cycle that contains the POs 610 is not illustrated in FIG. 6. A first SIB1 transmission is indicated by reference number 615. A second (updated) SIB1 transmission is indicated by reference number 620.

As shown, a network entity (e.g., network entity 300 or network entity 302) may transmit, and a UE (e.g., UE 104, UE 304) may receive, an SI change indication 625 (sometimes referred to as an SI change notification). For example, the UE may receive the SI change indication 625 via a short message on a PO 610 in a first SI modification period 605a. As shown, the UE may obtain updated system information (such as a second SIB1 transmission shown by reference number 620) in a second SI modification period 605b. Thus, upon receipt of the SI change indication 625 in a first SI modification period 605a, the UE may apply a SIB acquisition procedure at the start of a second (next) SI modification period 605b.

In some aspects, SIB1 typically may not change within an SI modification period 605, expect for a few specific information elements, such as si-BroadcastStatus. A boundary of an SI modification period 605 may represent a potential switch instance for a cell to change its configuration, since the cell may provide an SI change indication 625 prior to the boundary and may update the SI after the boundary such that UEs can obtain the updated SI. Furthermore, though different UEs may obtain SI change indications 625 at different POs 610, each of these UEs may be notified of the same switch time of the cell (e.g., of the cell's SI).

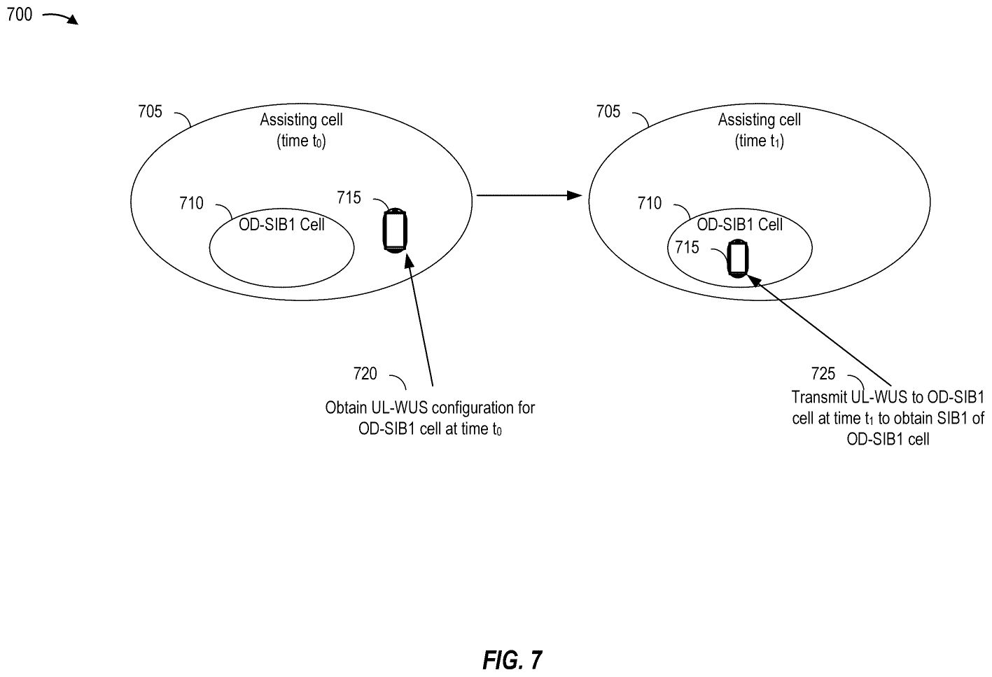

FIG. 7 is a diagram illustrating an example 700 of UL-WUS transmission in association with an assisting cell 705 and an OD-SIB1 cell 710. The OD-SIB1 cell 710 may be configured to transmit SIB1 on demand. For example, the OD-SIB1 cell 710 may not transmit SIB1 periodically. The assisting cell 705 may provide information regarding the UL-WUS transmission. For example, as shown by reference number 720, a UE 715 (e.g., UE 104, UE 304) may obtain an UL-WUS configuration for the OD-SIB1 cell 710 from the assisting cell 705 at a time t₀.

As shown by reference number 725, at a time t₁ which is later than t₀, the UE 715 may transmit the UL-WUS in order to obtain SIB1 from the OD-SIB1 cell 710. For example, the UE 715 may move into a coverage area of the OD-SIB1 cell 710. As another example (not illustrated), the UE 715 may be camped on the OD-SIB1 cell 710 for an extended length of time (such as longer than an SI modification period). If (t₀, t₁) belong to different SI modification periods (such as SI modification period 510 or SI modification period 605), the UE 715 may not know whether the previously acquired UL-WUS configuration (acquired at t₀ as indicated by reference number 720) is outdated or not. For example, an UL-WUS configuration may be expected to stay the same within an SI modification period, but may be updated across SI modification periods using an SI change notification (such as SI change notification 625).

If (t₀, t₁) belong to different SI modification periods, there is the possibility that the UL-WUS configuration has changed in an SI modification period after t₀ when the UE 715 is camping at OD-SIB1 cell 710. While camping at OD-SIB1 cell 710, the UE 715 may not monitor a paging physical downlink control channel (PDCCH) of the assisting cell 705, so the UE 715 may not know whether the UL-WUS configuration has changed or not.

One approach for the UE 715 to ensure the use of a valid UL-WUS configuration (thereby avoiding failed acquisition of SIB1) is to tune to the assisting cell 705 and perform a validity check of the UE 715's stored UL-WUS configuration based on a value tag before transmitting the UL-WUS. For example, the assisting cell 705 may periodically transmit SIB1, and may provide UL-WUS configurations for neighboring cells (such as OD-SIB1 cell 710) via a SIB X. To ensure that the UL-WUS configuration is valid, the UE 715 may tune to the assisting cell 705 (such as if the UE 715 was not previously tuned to the assisting cell 705 because the UE 715 was tuned to another cell such as the OD-SIB1 cell 710). The UE 715 may acquire SIB1 of the assisting cell 705. SIB1 may include a value tag for the SIB X. The UE 715 may check this value tag against a stored value tag for SIB X, thereby determining whether SIB X (and thus the UL-WUS configuration) has changed. If the value tags match one another, then there is no need to acquire an updated SIB X, and the UE 715 may send a UL-WUS (such as a physical random access channel (PRACH) transmission) according to the stored UL-WUS configuration for the OD-SIB1 cell 710. If the value tags do not match one another, the UE 715 may obtain SIB X. The UE 715 may update a stored UL-WUS configuration according to the SIB X. The UE 715 may send an UL-WUS (such as a PRACH transmission) according to the updated UL-WUS configuration.

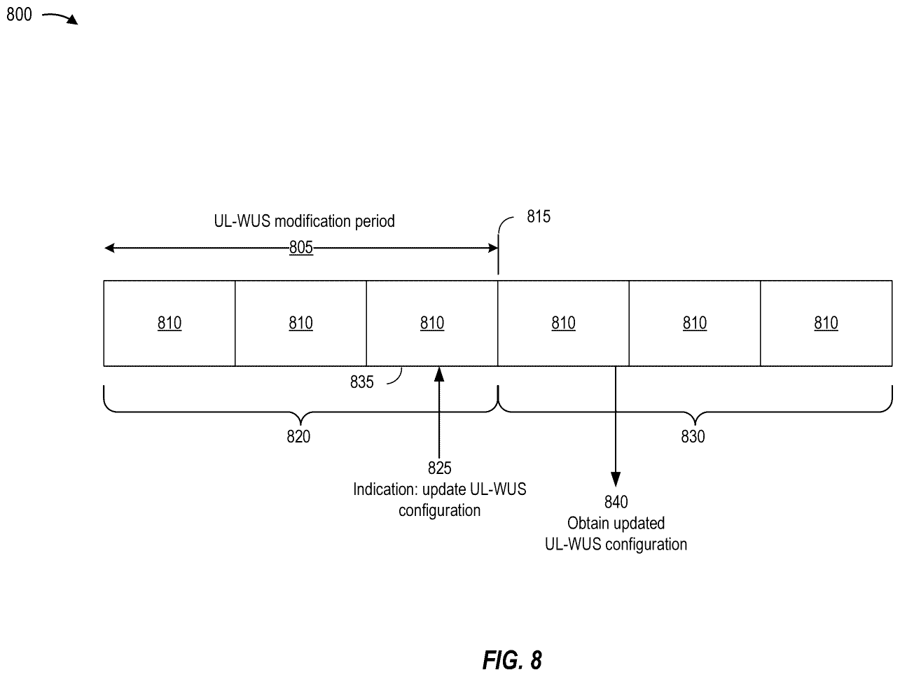

However, tuning to the assisting cell 705 each time an UL-WUS is to be transmitted may consume UE power. On the other hand, transmitting the UL-WUS without checking whether the UL-WUS has been updated may lead to interference at the network, UE power consumption, and failed SIB1 acquisition. An SI modification period may typically be defined in the range of a few hundred milliseconds to several seconds, so UE tuning may be expected to occur frequently. This may be particularly inefficient because UL-WUS configurations may be expected to rarely change. For example, UL-WUS configurations may be expected to change on a timescale longer than an SI modification period. Aspects described herein provide an UL-WUS modification period that, in some examples, may be longer than an SI modification period, as described in connection with FIG. 8.

FIG. 8 is a diagram illustrating an example 800 of an UL-WUS modification period 805. As shown, the UL-WUS modification period 805 is different than an SI modification period 810 (e.g., SI modification period 510 or SI modification period 605). For example, the UL-WUS modification period 805 may be longer than the SI modification period 810.

The UL-WUS modification period 805 may indicate a length of time for which an UL-WUS configuration is valid. For example, the UL-WUS modification period 805 may indicate a minimum length of time for which an UL-WUS configuration is valid. In some aspects, a UE (such as UE 104, UE 304, or UE 715) may not expect an UL-WUS configuration to change within the UL-WUS modification period 805. For example, a network entity (such as network entity 300 or network entity 302) may update an UL-WUS configuration only when crossing a boundary 815 of an UL-WUS modification period 805. In some examples, the UL-WUS modification period 805 may represent a length of time within which the UL-WUS configuration is unmodifiable, or unmodifiable by system information updating. After the UL-WUS modification period 805 has elapsed, the UL-WUS configuration may, or may not, be invalid. For example, the UL-WUS configuration may not be modified after the UL-WUS modification period 805 has elapsed, though the UE may check for updates to the UL-WUS configuration at this time, since the UL-WUS configuration could possibly change once the UL-WUS modification period has elapsed.

Thus, the UE can transmit UL-WUSs according to an UL-WUS configuration throughout an instance 820 of the UL-WUS modification period 805 without checking whether the UL-WUS configuration has been updated. This conserves power associated with tuning back to an assisting cell (such as assisting cell 705) and improves reliability of UL-WUS signaling.

The network entity may provide an indication of the UL-WUS modification period 805 to the UE. For example, the network entity may provide the indication in a SIB, such as a same SIB that provides the UL-WUS configuration or a different SIB than a SIB that provides the UL-WUS configuration.

As mentioned, an UL-WUS modification period 805 may be longer than an SI modification period 810. For example, the UL-WUS modification period 805 may be in a range of several minutes to several hours long. In some aspects, the UL-WUS modification period 805 may be defined using a hyper SFN number. For example, an SFN may include a number of subframes (e.g., 10 subframes of up to 1 ms each). A hyper SFN (sometimes referred to as a hyper frame number (HFN)) may include 1024 SFNs. A hyper SFN may be associated with a hyper SFN number. Starting at 0, a hyper SFN number may increment by 1 each time 1024 SFNs have elapsed. Hyper SFN numbers may support 1024 hyper SFNs. Thus, given 1 ms subframes, hyper SFN numbers can be used to indicate a length of time up to 2.91 hours. In some aspects, the UL-WUS modification period 805 may be defined according to a hyper SFN number. For example, the UL-WUS modification period 805 may be defined as starting at a particular hyper SFN number and/or SFN number (such as via a 20-bit indication of the hyper SFN number and/or SFN number. In this example, the UL-WUS modification period 805 may be defined to be 2.91 hours long, or may be shorter than 2.91 hours (such as by specifying a number of hyper SFN numbers and/or SFN numbers included in each UL-WUS modification period 805). Thus, the upper bound for the length of the UL-WUS modification period 805 may be comparable with the lifetime of an UL-WUS configuration, and may be equal to a maximum time span of the system.

In some aspects, a network entity may transmit an indication of an UL-WUS modification periodicity 805 in terms of a scaling factor for an SI modification periodicity 810. For example, an SI modification periodicity 810 may be defined according to a first parameter referred to as modificationPeriod. In some aspects, the first parameter may indicate a number of paging cycles (defaultPagingCycles) and a coefficient (modCoef) that indicates a scaling factor for the number of paging cycles: modificationPeriod=defaultPagingCycles*modCoef. The scaling factor that defines the UL-WUS modification periodicity 805 may be separate from the scaling factor for the number of paging cycles. For example, the scaling factor that defines the UL-WUS modification periodicity 805 may be referred to as coefWUS. In some aspects, the UL-WUS modification periodicity 805 (referred to as modificationPeriod_WUS) may be defined as: modificationPeriod_WUS=coefWUS*modificationPeriod. “Modification period” may be used interchangeably with “modification periodicity” herein.

In some aspects, parameters of an SI modification periodicity 810 may change. For example, a network entity may modify an SI modification periodicity by changing defaultPagingCycles*modCoef. In this situation, the UE may obtain the modification to the SI modification periodicity. However, if the UL-WUS modification periodicity 805 is defined in terms of a scaling factor for an SI modification periodicity 810, then a length of the UL-WUS modification periodicity 805 may change. This may be detrimental in the midst of an UL-WUS modification periodicity 805, or it may be beneficial to ensure that a length of the UL-WUS modification periodicity 805 is constant during the UL-WUS modification periodicity 805. In some aspects, in this situation, the network entity may also update the scaling factor that defines the UL-WUS modification periodicity 805 (coefWUS) such that the length of the UL-WUS modification periodicity 805 does not change (that is, is unchanged) during the UL-WUS modification periodicity 805. For example, in some aspects, to ensure modificationPeriod_WUS stays the same within a current modificationPeriod_WUS period, coefWUS shall be updated whenever modCoef or defaultPagingCycles are updated.

As shown, the network entity may provide, and the UE may receive, an indication 825 to update the UL-WUS configuration. For example, the indication 825 may include an SI change indication. In some aspects, the indication 825 may indicate the UL-WUS configuration. For example, the indication 825 may indicate that a SIB X, in which the UL-WUS configuration is provided, is updated. In some aspects, the indication 825 may not explicitly indicate the UL-WUS configuration. For example, the indication 825 may indicate that system information is updated, and the UE may obtain the updated system information (including the updated UL-WUS configuration) from the network entity.

In some aspects, the UE may receive the indication 825 at least one SI modification period before an end (at boundary 815) of a UL-WUS modification period 805. For example, to modify an UL-WUS configuration in an instance 830 of the UL-WUS modification period 805, the network entity may transmit (e.g., may be required to transmit) the indication 825 in the instance 820 of the UL-WUS modification period 805. For example, the indication 825 may be transmitted in, or earlier than, a final SI modification period shown by reference number 835. The UE may then obtain the updated UL-WUS configuration in the instance 830, as shown by reference number 840.

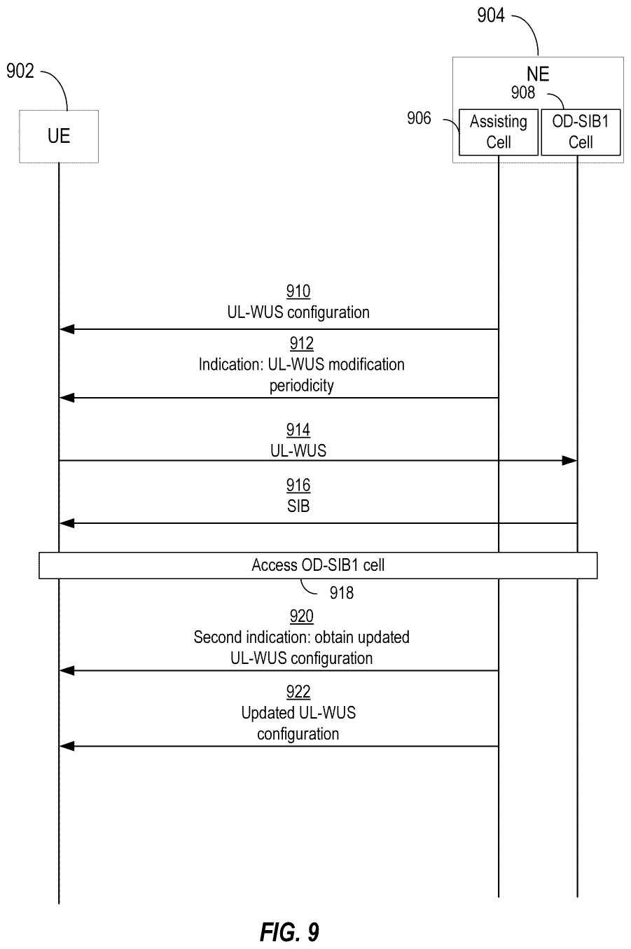

FIG. 9 is a diagram illustrating an example 900 of signaling associated with an UL-WUS modification period. Example 900 includes a UE 904 (e.g., UE 104, UE 304, UE 715) and a network entity 902 (e.g., BS 102, first network entity 300, second network entity 302). The network entity 902 may be associated with one or more of an assisting cell 906 (e.g., assisting cell 705) or an OD-SIB1 cell 908 (e.g., OD-SIB1 cell 710). The assisting cell 906 may be referred to as a first cell and the OD-SIB1 cell 908 may be referred to as a second cell. In example 900, the network entity 902 is illustrated as providing or managing both the assisting cell 906 or the OD-SIB1 cell 908. In some other aspects, the network entity 902 may provide only one of the assisting cell 906 or the OD-SIB1 cell 908. In some other aspects, the network entity 902 may provide neither the assisting cell 906 nor the OD-SIB1 cell 908.

As shown, the network entity 902 and/or the assisting cell 906 may send, and the UE 904 may obtain, a UL-WUS configuration 910. The UL-WUS configuration 910 is described in more detail in connection with FIGS. 5-8. As shown, the network entity 902 and/or the assisting cell 906 may send, and the UE 904 may obtain, an indication 912 of an UL-WUS modification periodicity (e.g., UL-WUS modification periodicity 805). In some aspects, the UL-WUS configuration 910 and the indication 912 may be transmitted together (e.g., as part of a same system information transmission). In some other aspects, the UL-WUS configuration 910 and the indication 912 may be transmitted separately (e.g., in separate SIB transmissions, such as at different times and/or in different SIBs).

In some aspects, the indication 912 may indicate a distance threshold, or the UE 904 may otherwise be provided with indication of a distance threshold. For example, the distance threshold may be indicated in a wireless communication specification, or the UE 904 may select a distance threshold. The distance threshold may indicate a maximum movement distance. In some aspects, if the UE 904 moves further than the maximum movement distance, then the UE 904 may discard the UL-WUS configuration 910. For example, the UE 904 may obtain an updated UL-WUS configuration 910, even if the UE 904 is within the pendency of an UL-WUS modification periodicity. In some aspects, the UE 904 may transmit capability information that indicates support for the distance threshold, and may be configured with the distance threshold in accordance with the capability information. For example, the capability information may indicate that the UE 904 has a capability for tracking a distance traveled by the UE 904.

As shown, the UE 904 may send, and the network entity 902 and/or the OD-SIB1 cell 908 may obtain, an UL-WUS 914. For example, the UE 904 may send the UL-WUS 914 in accordance with the UL-WUS configuration 910. As shown, the network entity 902 and/or the OD-SIB1 cell 908 may send a SIB 916 in response to the UL-WUS 914. As shown by reference number 918, the UE 904 may access the OD-SIB1 cell 908.

As shown, the network entity 902 and/or the assisting cell 906 may send, and the UE 904 may obtain, a second indication 920. The second indication 920 may indicate to obtain an updated UL-WUS configuration, as described with regard to FIG. 8. As shown, at reference number 922, the UE 904 may obtain the updated UL-WUS configuration in accordance with the second indication 920 being valid. The second indication 920 may be valid if the second indication 920 is received in a first UL-WUS modification periodicity and indicates to obtain an updated UL-WUS configuration in a second UL-WUS modification periodicity (e.g., if the second indication 920 is received prior to an end of the first UL-WUS modification periodicity). Thus, the UE 904 may obtain the second indication 920 prior to an end of the first UL-WUS modification periodicity, and may obtain the updated UL-WUS configuration after an end of the first UL-WUS modification periodicity.

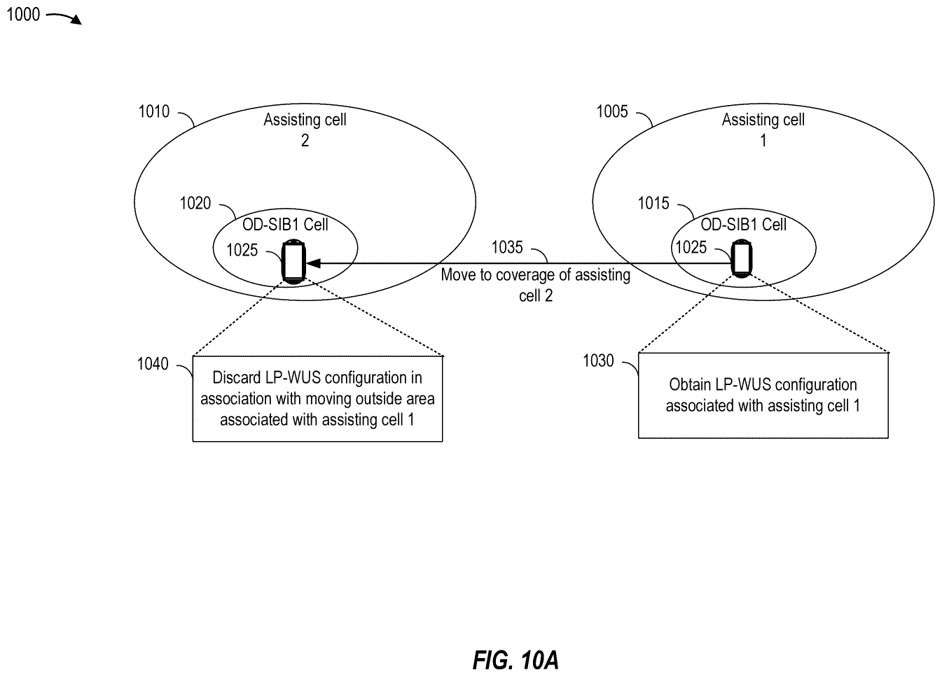

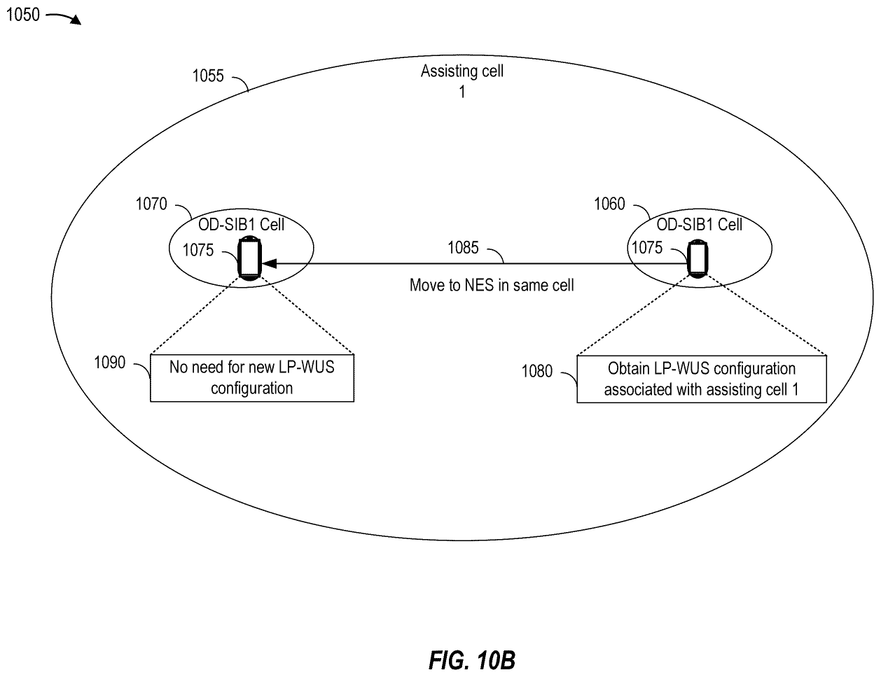

FIG. 10A is a diagram illustrating an example 1000 of discarding an UL-WUS configuration based on an area. Example 1000 includes a first assisting cell 1005 (e.g., assisting cell 906), a second assisting cell 1010 (e.g., assisting cell 906), a first OD-SIB1 cell 1015 (e.g., OD-SIB1 cell 908), and a second OD-SIB1 cell 1020 (e.g., OD-SIB1 cell 908). In some aspects, the first assisting cell 1005 may be referred to as a first cell, the first OD-SIB1 cell 1015 may be referred to as a second cell, and the second assisting cell 1010 may be referred to as a third cell. As further shown, example 1000 includes a UE 1025 (e.g., UE 104, UE 304, UE 904).

At 1030, the UE 1025 may obtain an LP-WUS configuration. For example, the UE 1025 may obtain the LP-WUS configuration from the first assisting cell 1005 via a SIB. In some aspects, the LP-WUS configuration may be associated with the first assisting cell 1005. For example, the LP-WUS configuration may be specific to a tracking area or a RAN notification area (RNA) of the first assisting cell 1005.

At 1035, the UE 1025 may move from a coverage area of the first assisting cell 1005 to a coverage area of the second assisting cell 1010. In this example, the UE 1025 is now in a coverage area of the second OD-SIB1 cell 1020, and was formerly in a coverage area of the first OD-SIB1 cell 1015. In some aspects, the UE 1025 may determine that the UE 1025 has moved to the coverage area of the second assisting cell 1010. For example, the UE 1025 may determine that the UE 1025 has moved out of an area associated with the first assisting cell 1005. In some aspects, the UE 1025 may determine that the UE 1025 has moved out of the area associated with the first assisting cell 1005 based at least in part on receiving information indicating an area associated with another cell, such as a tracking area identifier or an RNA identifier of the second assisting cell 1010.

At 1040, the UE 1025 may discard the UL-WUS configuration. For example, the UE 1025 may discard the UL-WUS configuration in association with moving out of the area associated with the first assisting cell 1005. In some aspects, the UE 1025 may discard the UL-WUS configuration prior to an end of an LP-WUS modification period. This may be beneficial in a situation where the second OD-SIB1 cell 1020 has a same cell identifier and frequency as the first OD-SIB1 cell 1015, such that the UE 1025 could mistakenly use the UL-WUS configuration of the first OD-SIB1 cell 1015 to transmit a UL-WUS to the second OD-SIB1 cell 1020. In some aspects, the UE 1025 may obtain an updated UL-WUS configuration from the second assisting cell 1010. The UE 1025 may transmit a UL-WUS to the second OD-SIB1 cell 1020 using the updated UL-WUS configuration.

FIG. 10B is a diagram illustrating an example 1050 of retaining a UL-WUS configuration based on an area. Example 1050 includes an assisting cell 1055 (e.g., assisting cell 906, first assisting cell 1005), a first OD-SIB1 cell 1060 (e.g., OD-SIB1 cell 908), and a second OD-SIB1 cell 1070 (e.g., OD-SIB1 cell 908). As further shown, example 1050 includes a UE 1075 (e.g., UE 104, UE 304, UE 904).

At 1080, the UE 1075 may obtain an LP-WUS configuration. For example, the UE 1075 may obtain the LP-WUS configuration from the assisting cell 1055 via a SIB. In some aspects, the LP-WUS configuration may be associated with the assisting cell 1055. For example, the LP-WUS configuration may be specific to a tracking area or an RNA of the assisting cell 1055.

At 1085, the UE 1075 may move within a coverage area of the assisting cell 1055. In this example, the UE 1075 is now in a coverage area of the second OD-SIB1 cell 1070, and was formerly in a coverage area of the first OD-SIB1 cell 1060. However, because both the first OD-SIB1 cell 1060 and the second OD-SIB1 cell 1070 are within the coverage area of the same assisting cell 1055, there is no need to acquire an updated UL-WUS configuration.

At 1090, the UE 1075 may retain the UL-WUS configuration in accordance with the UL-WUS modification periodicity described herein and based on the UE 1075 not having moved to a new coverage area. As a result, applying the longer UL-WUS update periodicity mentioned above may be beneficial since the acquisition of a new UL-WUS configuration is not necessary in moving between the first OD-SIB1 cell 1060 and the second OD-SIB1 cell 1070. This may be particularly beneficial since, in some cases, an OD-SIB1 cell may not provide UL-WUS configuration updates for the OD-SIB1 cell, so without the UL-WUS modification periodicity, the UE 1075 may have to tune to the assisting cell 1055 to obtain the UL-WUS configuration update.

Furthermore, example 1050 can be combined with example 1000. For example, the UE 1075 may discard the UL-WUS configuration upon moving to the coverage area of second assisting cell 1010 and obtain an updated UL-WUS configuration from the second assisting cell 1010, even if an OD-SIB1 cell (e.g., 1020) of the second assisting cell 1010 has a same cell identifier and frequency as an OD-SIB1 cell of the assisting cell 1055. However, while in the coverage area of the assisting cell 1055 (e.g., assisting cell 1005), the UE 1075 may obtain UL-WUS configuration updates according to the UL-WUS modification periodicity, even if the UE 1075 switches from being camped on the first OD-SIB1 cell 1060 to the second OD-SIB1 cell 1070 multiple times during the UL-WUS modification periodicity. Thus, overhead and power consumption at the UE 1075 are reduced.

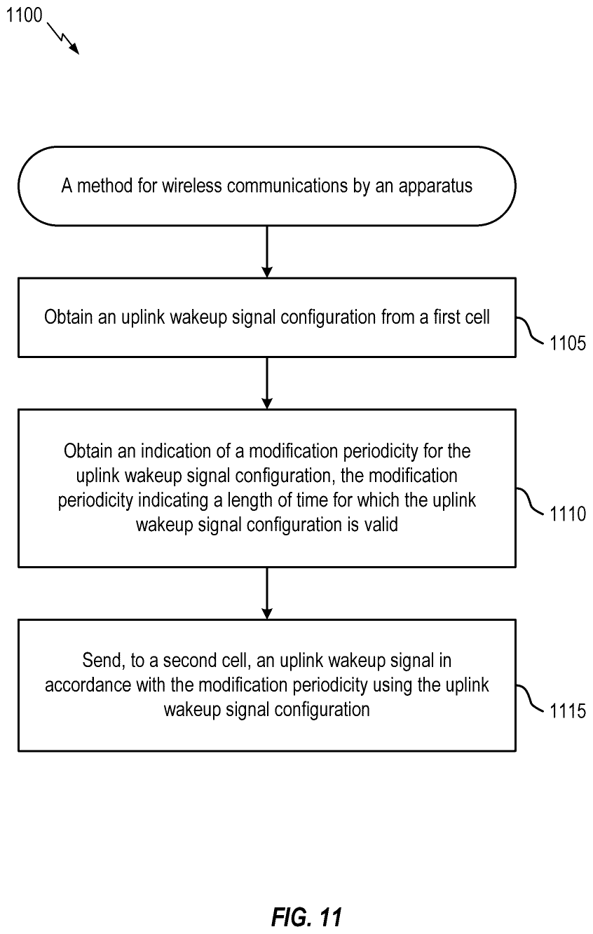

FIG. 11 shows a method 1100 for wireless communications by an apparatus, such as UE 104 or 304 of FIGS. 1 and 3.

Method 1100 begins at block 1105 with obtaining an uplink wakeup signal configuration from a first cell (as described, for example, with regard to UL-WUS configuration 910).

Method 1100 then proceeds to block 1110 with obtaining an indication (such as indication 912) of a modification periodicity (such as UL-WUS modification periodicity 805) for the uplink wakeup signal configuration, the modification periodicity indicating a length of time for which the uplink wakeup signal configuration is valid.

Method 1100 then proceeds to block 1115 with sending, to a second cell, an uplink wakeup signal (such as UL-WUS 914) in accordance with the modification periodicity using the uplink wakeup signal configuration.

In some aspects, the length of time is a minimum length of time for which the uplink wakeup signal configuration is valid.

In some aspects, method 1100 further includes obtaining an indication of a system information modification periodicity for the first cell, wherein the system information modification periodicity is different than the modification periodicity for the uplink wakeup signal configuration.

In some aspects, the system information modification periodicity has a first time length, the modification periodicity for the uplink wakeup signal configuration has a second time length, and the first time length is shorter than the second time length.

In some aspects, the indication of the modification periodicity indicates a hyper system frame number.

In some aspects, the indication indicates a distance threshold, wherein the distance threshold indicates a maximum movement distance of the UE.

In some aspects, method 1100 further includes discarding the uplink wakeup signal configuration in association with having moved further than the maximum movement distance.

In some aspects, causing the UE to discard the uplink wakeup signal configuration comprises discarding the uplink wakeup signal configuration prior to an end of the length of time.

In some aspects, method 1100 further includes obtaining an updated uplink wakeup signal configuration in accordance with having moved further than the maximum movement distance.

In some aspects, method 1100 further includes discarding the uplink wakeup signal configuration in association with having moved further than a maximum movement distance.

In some aspects, method 1100 further includes discarding the uplink wakeup signal configuration in association with moving outside of an area associated with the first cell.

In some aspects, causing the UE to discard the uplink wakeup signal configuration comprises discarding the uplink wakeup signal configuration prior to an end of the length of time.

In some aspects, the area comprises at least one of a tracking area or a radio access network notification area.

In some aspects, causing the UE to discard the uplink wakeup signal configuration comprises discarding the uplink wakeup signal configuration in response to receiving information indicating an area associated with a third cell.

In some aspects, the indication of the modification periodicity comprises a scaling factor for a system information modification periodicity, and wherein the method 1100 further comprises: obtaining a modification of the system information modification periodicity; and obtaining a modification of the scaling factor such that the length of time is unchanged in association with the modification of the system information modification periodicity.

In some aspects, the indication is a first indication and the method 1100 further comprises obtaining a second indication to obtain an updated uplink wakeup signal configuration, wherein the second indication is valid in association with being received prior to an end of the length of time.

In some aspects, method 1100 further includes obtaining the updated uplink wakeup signal configuration after the end of the length of time.

In some aspects, the indication is a first indication and the method 1100 further comprises: obtaining a second indication to obtain an updated uplink wakeup signal configuration prior to an end of the length of time; and obtaining the updated uplink wakeup signal configuration after the end of the length of time.

In some aspects, the length of time includes a plurality of system information modification periods including a final system information modification period, and wherein the second indication is in a system information modification period, of the plurality of system information modification periods, prior to the final system information modification period.

In some aspects, method 1100 further includes obtaining an updated uplink wakeup signal configuration that indicates an updated modification periodicity.

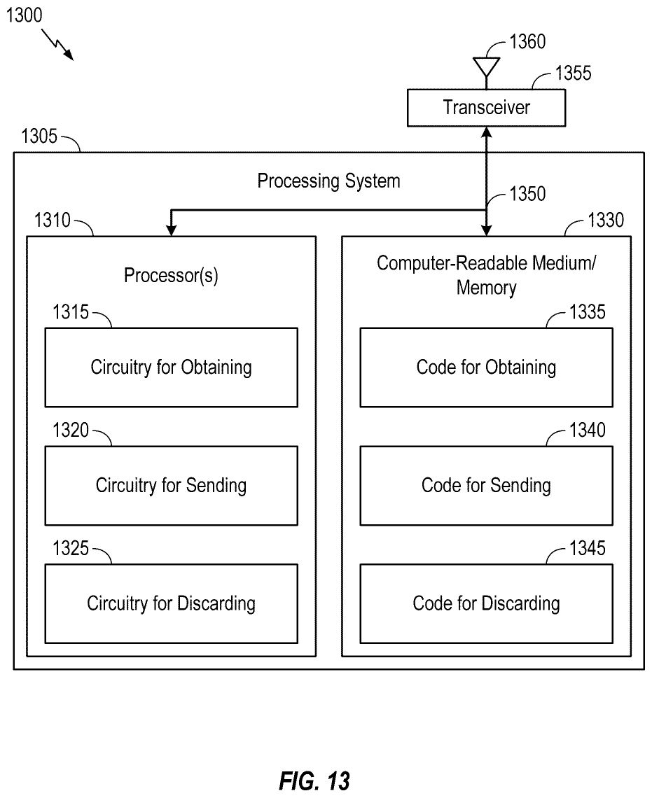

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

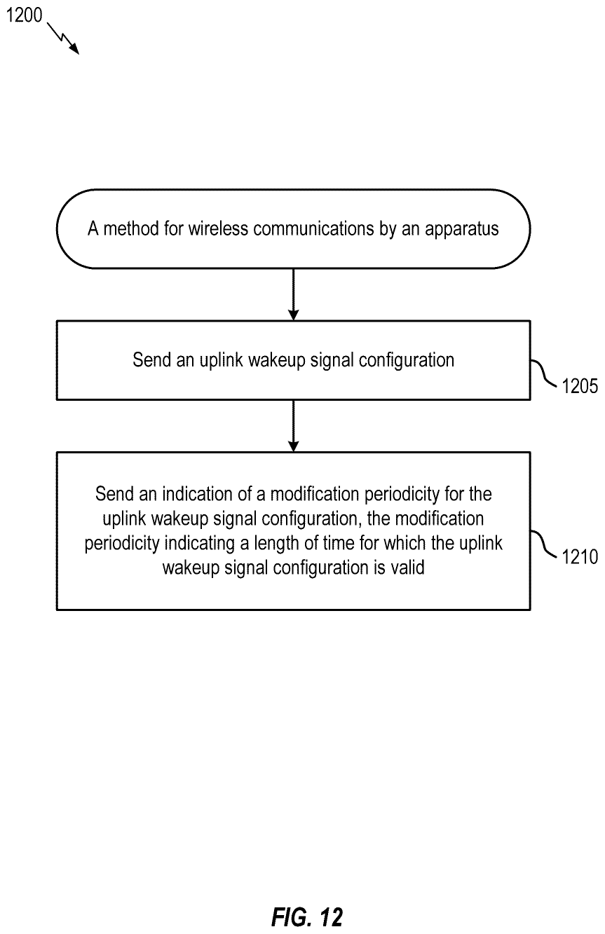

FIG. 12 shows a method 1200 for wireless communications by an apparatus, such as BS 102 or network entity 300 or 302 of FIGS. 1 and 3, or a disaggregated base station as discussed with respect to FIG. 2.

Method 1200 begins at block 1205 with sending an uplink wakeup signal configuration (as described, for example, with regard to UL-WUS configuration 910).

Method 1200 then proceeds to block 1210 with sending an indication (such as indication 912) of a modification periodicity (such as UL-WUS modification periodicity 805) for the uplink wakeup signal configuration, the modification periodicity indicating a length of time for which the uplink wakeup signal configuration is valid.

In some aspects, the length of time is a minimum length of time for which the uplink wakeup signal configuration is valid.

In certain aspects, method 1200 further includes sending an indication of a system information modification periodicity, wherein the system information modification periodicity is different than the modification periodicity for the uplink wakeup signal configuration.

In some aspects, the system information modification periodicity has a first time length, the modification periodicity for the uplink wakeup signal configuration has a second time length, and the first time length is shorter than the second time length.

In some aspects, the indication of the modification periodicity indicates a hyper system frame number.

In some aspects, the indication indicates a distance threshold, wherein the distance threshold indicates a maximum movement distance.

In some aspects, the indication of the modification periodicity comprises a scaling factor for a system information modification periodicity, and wherein the method 1200 further comprises: sending a modification of the system information modification periodicity; and sending a modification of the scaling factor such that the length of time is unchanged in association with the modification of the system information modification periodicity.

In some aspects, the indication is a first indication and the method 1200 further comprises sending a second indication to obtain an updated uplink wakeup signal configuration, wherein the second indication is valid in association with being sent prior to an end of the length of time.

In certain aspects, method 1200 further includes sending the updated uplink wakeup signal configuration at or after the end of the length of time.

In some aspects, the indication is a first indication and the method 1200 further comprises: sending a second indication to obtain an updated uplink wakeup signal configuration prior to an end of the length of time; and sending the updated uplink wakeup signal configuration after the end of the length of time.

In some aspects, the length of time includes a plurality of system information modification periods including a final system information modification period, and wherein the second indication is in a system information modification period, of the plurality of system information modification periods, prior to the final system information modification period.

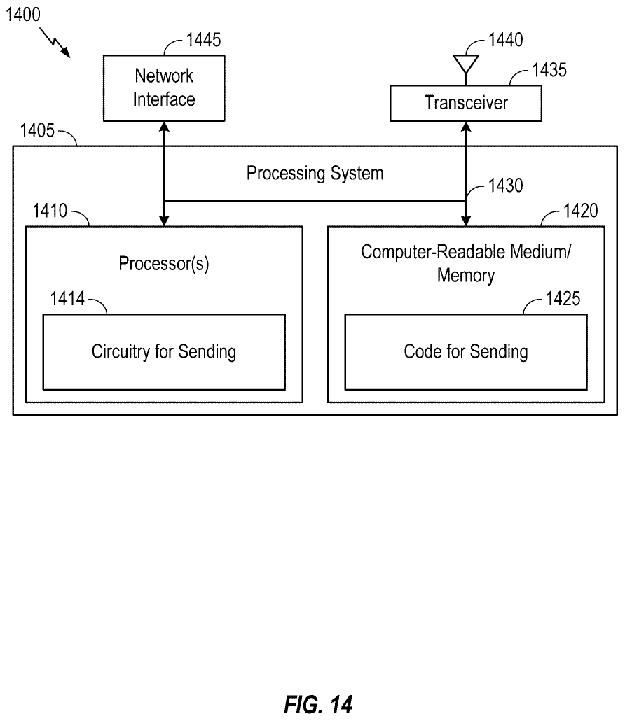

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a user equipment, such as UE 104 or UE 304 described above with respect to FIGS. 1 and 3.

The communications device 1300 includes a processing system 1305 coupled to a transceiver 1355 (e.g., a transmitter and/or a receiver). The transceiver 1355 is configured to transmit and receive signals for the communications device 1300 via an antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more processors 314 as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code), including code 1335-1345, that when executed by the one or more processors 1310, enable and cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1330 stores code for obtaining 1335, code for sending 1340, and code for discarding 1345. Processing of the code 1335-1345 may enable and cause the communications device 1300 to perform the method 1100 described with respect to FIG. 11, or any aspect related to it.

The one or more processors 1310 include circuitry configured to implement (e.g., execute) the code (e.g., executable instructions) stored in the computer-readable medium/memory 1330, including circuitry for obtaining 1315, circuitry for sending 1320, and circuitry for discarding 1325. Processing with circuitry 1315-1325 may enable and cause the communications device 1300 to perform the method 1100 described with respect to FIG. 11, or any aspect related to it.

More generally, means for communicating, transmitting, sending or outputting for transmission may include the transceiver 320, antenna 318, one or more memories 316, or one or more processors 314 of the UE 304 illustrated in FIG. 3, transceiver 1355 and/or antenna 1360 of the communications device 1300 in FIG. 13, and/or one or more processors 1310 of the communications device 1300 in FIG. 13. Means for communicating, receiving or obtaining may include the transceiver 320, antenna 318, one or more memories 316, or one or more processors 314 of the UE 304 illustrated in FIG. 3, transceiver 1355 and/or antenna 1360 of the communications device 1300 in FIG. 13, and/or one or more processors 1310 of the communications device 1300 in FIG. 13.

FIG. 14 depicts aspects of an example communications device 1400. In some aspects, communications device 1400 is a network entity, such as BS 102 of FIG. 1, network entity 300 or 302 of FIG. 3, or a disaggregated base station as discussed with respect to FIG. 2.

The communications device 1400 includes a processing system 1405 coupled to a transceiver 1435 (e.g., a transmitter and/or a receiver) and/or a network interface 1445. The transceiver 1435 is configured to transmit and receive signals for the communications device 1400 via an antenna 1440, such as the various signals as described herein. The network interface 1445 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more processors 306, as described with respect to FIG. 3. The one or more processors 1410 are coupled to a computer-readable medium/memory 1420 via a bus 1430. In certain aspects, the computer-readable medium/memory 1420 is configured to store instructions (e.g., computer-executable code), including code for sending 1425, that when executed by the one or more processors 1410, enable and cause the one or more processors 1410 to perform the method 1200 described with respect to FIG. 12, or any aspect related to it, including any operations described in relation to FIG. 12. Note that reference to a processor of communications device 1400 performing a function may include one or more processors of communications device 1400 performing that function, such as in a distributed fashion.

In the depicted example, the computer-readable medium/memory 1420 stores code for sending 1425. Processing of the code for sending 1425 may enable and cause the communications device 1400 to perform the method 1200 described with respect to FIG. 12, or any aspect related to it.

The one or more processors 1410 include circuitry configured to implement (e.g., execute) the code (e.g., executable instructions) stored in the computer-readable medium/memory 1420, including circuitry for sending 1415. Processing with circuitry for sending 1415 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the transceiver 310, antenna 312, one or more memories 308, or one or more processors 306 of the network entity 300 or 302 illustrated in FIG. 3, transceiver 1435, antenna 1440, and/or network interface 1445 of the communications device 1400 in FIG. 14, and/or one or more processors 1410 of the communications device 1400 in FIG. 14. Means for communicating, receiving or obtaining may include the transceiver 310, antenna 312, one or more memories 308, or one or more processors 306 of the network entity 300 or 302 illustrated in FIG. 3, transceiver 1435, antenna 1440, and/or network interface 1445 of the communications device 1400 in FIG. 14, and/or one or more processors 1410 of the communications device 1400 in FIG. 14.

### Example Clauses

Implementation examples are described in the following numbered clauses:
Clause 1: A method for wireless communications by an apparatus comprising: obtaining an uplink wakeup signal configuration from a first cell; obtaining an indication of a modification periodicity for the uplink wakeup signal configuration, the modification periodicity indicating a length of time for which the uplink wakeup signal configuration is valid; and sending, to a second cell, an uplink wakeup signal in accordance with the modification periodicity using the uplink wakeup signal configuration.
Clause 2: The method of Clause 1, wherein the length of time is a minimum length of time for which the uplink wakeup signal configuration is valid.
Clause 3: The method of any one of Clauses 1-2, further comprising obtaining an indication of a system information modification periodicity for the first cell, wherein the system information modification periodicity is different than the modification periodicity for the uplink wakeup signal configuration.
Clause 4: The method of Clause 3, wherein the system information modification periodicity has a first time length, the modification periodicity for the uplink wakeup signal configuration has a second time length, and the first time length is shorter than the second time length.
Clause 5: The method of any one of Clauses 1-4, wherein the indication of the modification periodicity indicates a hyper system frame number.
Clause 6: The method of any one of Clauses 1-5, wherein the indication indicates a distance threshold, wherein the distance threshold indicates a maximum movement distance of the UE.
Clause 7: The method of Clause 6, further comprising discarding the uplink wakeup signal configuration in association with having moved further than the maximum movement distance.
Clause 8: The method of Clause 7, wherein causing the UE to discard the uplink wakeup signal configuration comprises discarding the uplink wakeup signal configuration prior to an end of the length of time.
Clause 9: The method of Clause 6, further comprising obtaining an updated uplink wakeup signal configuration in accordance with having moved further than the maximum movement distance.
Clause 10: The method of any one of Clauses 1-9, further comprising discarding the uplink wakeup signal configuration in association with having moved further than a maximum movement distance.
Clause 11: The method of any one of Clauses 1-10, further comprising discarding the uplink wakeup signal configuration in association with moving outside of an area associated with the first cell.
Clause 12: The method of Clause 11, wherein causing the UE to discard the uplink wakeup signal configuration comprises discarding the uplink wakeup signal configuration prior to an end of the length of time.
Clause 13: The method of Clause 11, wherein the area comprises at least one of a tracking area or a radio access network notification area.
Clause 14: The method of Clause 11, wherein causing the UE to discard the uplink wakeup signal configuration comprises discarding the uplink wakeup signal configuration in response to receiving information indicating an area associated with a third cell.
Clause 15: The method of any one of Clauses 1-14, wherein the indication of the modification periodicity comprises a scaling factor for a system information modification periodicity, and wherein the method further comprises: obtaining a modification of the system information modification periodicity; and obtaining a modification of the scaling factor such that the length of time is unchanged in association with the modification of the system information modification periodicity.
Clause 16: The method of any one of Clauses 1-15, wherein the indication is a first indication and the method further comprises obtaining a second indication to obtain an updated uplink wakeup signal configuration, wherein the second indication is valid in association with being received prior to an end of the length of time.
Clause 17: The method of Clause 16, further comprising obtaining the updated uplink wakeup signal configuration after the end of the length of time.
Clause 18: The method of any one of Clauses 1-17, wherein the indication is a first indication and the method further comprises: obtaining a second indication to obtain an updated uplink wakeup signal configuration prior to an end of the length of time; and obtaining the updated uplink wakeup signal configuration after the end of the length of time.
Clause 19: The method of Clause 18, wherein the length of time includes a plurality of system information modification periods including a final system information modification period, and wherein the second indication is in a system information modification period, of the plurality of system information modification periods, prior to the final system information modification period.
Clause 20: The method of any one of Clauses 1-19, further comprising obtaining an updated modification periodicity.
Clause 21: A method for wireless communications by an apparatus comprising: sending an uplink wakeup signal configuration; and sending an indication of a modification periodicity for the uplink wakeup signal configuration, the modification periodicity indicating a length of time for which the uplink wakeup signal configuration is valid.
Clause 22: The method of Clause 21, wherein the length of time is a minimum length of time for which the uplink wakeup signal configuration is valid.
Clause 23: The method of any one of Clauses 21-22, further comprising sending an indication of a system information modification periodicity, wherein the system information modification periodicity is different than the modification periodicity for the uplink wakeup signal configuration.
Clause 24: The method of Clause 23, wherein the system information modification periodicity has a first time length, the modification periodicity for the uplink wakeup signal configuration has a second time length, and the first time length is shorter than the second time length.
Clause 25: The method of any one of Clauses 21-24, wherein the indication of the modification periodicity indicates a hyper system frame number.
Clause 26: The method of any one of Clauses 21-25, wherein the indication indicates a distance threshold, wherein the distance threshold indicates a maximum movement distance.
Clause 27: The method of any one of Clauses 21-26, wherein the indication of the modification periodicity comprises a scaling factor for a system information modification periodicity, and wherein the method further comprises: sending a modification of the system information modification periodicity; and sending a modification of the scaling factor such that the length of time is unchanged in association with the modification of the system information modification periodicity.
Clause 28: The method of any one of Clauses 21-27, wherein the indication is a first indication and the method further comprises sending a second indication to obtain an updated uplink wakeup signal configuration, wherein the second indication is valid in association with being sent prior to an end of the length of time.
Clause 29: The method of Clause 28, further comprising sending the updated uplink wakeup signal configuration at or after the end of the length of time.
Clause 30: The method of any one of Clauses 21-29, wherein the indication is a first indication and the method further comprises: sending a second indication to obtain an updated uplink wakeup signal configuration prior to an end of the length of time; and sending the updated uplink wakeup signal configuration after the end of the length of time.
Clause 31: The method of Clause 30, wherein the length of time includes a plurality of system information modification periods including a final system information modification period, and wherein the second indication is in a system information modification period, of the plurality of system information modification periods, prior to the final system information modification period.
Clause 32: One or more apparatuses, comprising: one or more memories comprising executable instructions; and one or more processors configured to execute the executable instructions and cause the one or more apparatuses to perform a method in accordance with any one of Clauses 1-31.

Clause 33: One or more apparatuses, comprising: one or more memories; and one or more processors, coupled to the one or more memories, configured to cause the one or more apparatuses to perform a method in accordance with any one of Clauses 1-31.
Clause 34: One or more apparatuses, comprising: one or more memories; and one or more processors, coupled to the one or more memories, configured to perform a method in accordance with any one of Clauses 1-31.
Clause 35: One or more apparatuses, comprising means for performing a method in accordance with any one of Clauses 1-31.
Clause 36: One or more non-transitory computer-readable media comprising executable instructions that, when executed by one or more processors of one or more apparatuses, cause the one or more apparatuses to perform a method in accordance with any one of Clauses 1-31.
Clause 37: One or more computer program products embodied on one or more computer-readable storage media comprising code for performing a method in accordance with any one of Clauses 1-31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), a system in package (SiP), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus of a user equipment (UE) configured for wireless communications, comprising: one or more memories; and one or more processors coupled to the one or more memories and configured to cause the UE to:
obtain an uplink wakeup signal configuration from a first cell;
obtain an indication of a modification periodicity for the uplink wakeup signal configuration, the modification periodicity indicating a length of time for which the uplink wakeup signal configuration is valid; and
send, to a second cell, an uplink wakeup signal in accordance with the modification periodicity using the uplink wakeup signal configuration.

2. The apparatus of claim 1, wherein the length of time is a minimum length of time for which the uplink wakeup signal configuration is valid.

3. The apparatus of claim 1, wherein the one or more processors are configured to cause the UE to obtain an indication of a system information modification periodicity for the first cell, wherein the system information modification periodicity is different than the modification periodicity for the uplink wakeup signal configuration.

4. The apparatus of claim 3, wherein the system information modification periodicity has a first time length, the modification periodicity for the uplink wakeup signal configuration has a second time length, and the first time length is shorter than the second time length.

5. The apparatus of claim 1, wherein the indication of the modification periodicity indicates a hyper system frame number.

6. The apparatus of claim 1, wherein the indication indicates a distance threshold, wherein the distance threshold indicates a maximum movement distance of the UE.

7. The apparatus of claim 6, wherein the one or more processors are configured to cause the UE to discard the uplink wakeup signal configuration in association with having moved further than the maximum movement distance.

8. The apparatus of claim 7, wherein to cause the UE to discard the uplink wakeup signal configuration, the one or more processors are configured to cause the UE to discard the uplink wakeup signal configuration prior to an end of the length of time.

9. The apparatus of claim 6, wherein the one or more processors are configured to cause the UE to obtain an updated uplink wakeup signal configuration in accordance with having moved further than the maximum movement distance.

10. The apparatus of claim 1, wherein the one or more processors are configured to cause the UE to discard the uplink wakeup signal configuration in association with having moved further than a maximum movement distance.

11. The apparatus of claim 1, wherein the one or more processors are configured to cause the UE to discard the uplink wakeup signal configuration in association with moving outside of an area associated with the first cell.

12. The apparatus of claim 11, wherein to cause the UE to discard the uplink wakeup signal configuration, the one or more processors are configured to cause the UE to discard the uplink wakeup signal configuration prior to an end of the length of time.

13. The apparatus of claim 11, wherein the area comprises at least one of a tracking area or a radio access network notification area.

14. The apparatus of claim 11, wherein to cause the UE to discard the uplink wakeup signal configuration, the one or more processors are configured to cause the UE to discard the uplink wakeup signal configuration in response to receiving information indicating an area associated with a third cell.

15. The apparatus of claim 1, wherein the indication of the modification periodicity comprises a scaling factor for a system information modification periodicity, and wherein the one or more processors are configured to cause the UE to:
obtain a modification of the system information modification periodicity; and
obtain a modification of the scaling factor such that the length of time is unchanged in association with the modification of the system information modification periodicity.

16. The apparatus of claim 1, wherein the indication is a first indication and the one or more processors are configured to cause the UE to obtain a second indication to obtain an updated uplink wakeup signal configuration, wherein the second indication is valid in association with being received prior to an end of the length of time.

17. The apparatus of claim 16, wherein the one or more processors are configured to cause the UE to obtain the updated uplink wakeup signal configuration after the end of the length of time.

18. An apparatus of a network entity configured for wireless communications, comprising: one or more memories; and one or more processors coupled to the one or more memories and configured to cause the network entity to:
send an uplink wakeup signal configuration; and
send an indication of a modification periodicity for the uplink wakeup signal configuration, the modification periodicity indicating a length of time for which the uplink wakeup signal configuration is valid.

19. The apparatus of claim 18, wherein the length of time is a minimum length of time for which the uplink wakeup signal configuration is valid.

20. A method of wireless communications at a user equipment (UE), comprising:
obtaining an uplink wakeup signal configuration from a first cell;
obtaining an indication of a modification periodicity for the uplink wakeup signal configuration, the modification periodicity indicating a length of time for which the uplink wakeup signal configuration is valid; and
sending, to a second cell, an uplink wakeup signal in accordance with the modification periodicity using the uplink wakeup signal configuration.
